(19) United States
(12) Patent Application Publication
(10) Pub. No.: US 2012/0246184 A1
(43) Pub. Date: Sep. 27, 2012

(54) STORING AND RETRIEVING INFORMATION ASSOCIATED WITH A DIGITAL IMAGE

(75) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/491,105

(22) Filed: Jun. 7, 2012

Related U.S. Application Data
(63) Continuation-in-part of application No. 13/311,204, filed on Dec. 5, 2011.
Application No. 13/311,204 is a continuation-in-part of application No. 12/884,941, filed on Sep. 17, 2010.
Application No. 12/884,941 is a continuation-in-part of application No. 12/290,066, filed on Oct. 27, 2008, now Pat. No. 7,995,118.
Application No. 12/290,066 is a continuation of application No. 10/998,691, filed on Nov. 29, 2004, now Pat. No. 7,450,163.
Application No. 12/884,941 is a continuation-in-part of application No. 12/290,258, filed on Oct. 29, 2008.
Application No. 12/290,258 is a continuation of application No. 11/051,069, filed on Feb. 4, 2005, now Pat. No. 7,456,872.
Application No. 11/051,069 is a continuation-in-part of application No. 11/020,459, filed on Dec. 22, 2004.
Application No. 11/020,459 is a continuation-in-part of application No. 10/998,691, filed on Nov. 29, 2004, now Pat. No. 7,450,163.
Application No. 12/884,941 is a continuation-in-part of application No. 12/860,404, filed on Aug. 20, 2010.

(51) Int. Cl. G06F 17/30

(52) U.S. Cl. 707/758; 707/705; 707/E17.014; 707/E17.019

(57) ABSTRACT

A method and apparatus for receiving an indication of selection of a hotspot on an image are disclosed. A file associated with the hotspot on the image is determined. The file is transmitted for execution.

### CROSS-REFERENCE TO RELATED APPLICATION

This application is a continuation-in-part of patent application Ser. No. 13/311,204, filed Dec. 5, 2011 entitled SYSTEM AND METHOD OF STORING AND RETRIEVING INFORMATION ASSOCIATED WITH A DIGITAL IMAGE, which is a continuation-in-part of U.S. patent application Ser. No. 12/884,941, filed Sep. 17, 2010, which is a continuation-in-part-of U.S. patent application Ser. No. 12/290,066, filed Oct. 27, 2008, now U.S. Pat. No. 7,995,118, the entirety of which in incorporated herein by reference, and which is a continuation of U.S. patent application Ser. No. 10/998,691, filed Nov. 29, 2004, now U.S. Pat. No. 7,450,163, the entirety of which is incorporated herein by reference. U.S. patent application Ser. No. 12/884,941 is also a continuation-in-part of U.S. patent application Ser. No. 12/290,258, filed on Oct. 29, 2008, the entirety of which is incorporated herein by reference, and which is a continuation of U.S. patent application Ser. No. 11/051,069, filed on Feb. 4, 2005, now U.S. Pat. No. 7,456,872, the entirety of which is incorporated herein by reference, and which is a continuation-in-part of U.S. patent application Ser. No. 11/020,459, filed on Dec. 22, 2004, the entirety of which is incorporated herein by reference, and which is a continuation-in-part of U.S. patent application Ser. No. 10/998,691, filed on Nov. 29, 2004, now U.S. Pat. No. 7,450,163, the entirety of which is incorporated herein by reference. U.S. patent application Ser. No. 12/884,941 is also a continuation-in-part of U.S. patent application Ser. No. 12/860,404, filed on Aug. 20, 2010, the entirety of which is incorporated herein by reference.

### STATEMENT REGARDING FEDERALLY SPONSORED RESEARCH OR DEVELOPMENT

n/a

### FIELD OF THE INVENTION

A method and system for managing digital images, and more particularly to a method and system for associating data with a digital image.

### BACKGROUND OF THE INVENTION

Millions of images are captured each day by individuals around the globe. Many of these images are stored in the local storage or external storage of a computer, from which they can be accessed and viewed at any time after image capture. Many of these digital images are uploaded to websites on the World Wide Web (WWW), i.e., the Internet. On the Web, other users can access and view the images. In many cases the user can also click on the image and be directed to a different part of a website or to a totally different website.

Digital images that are routinely captured usually contain embedded metadata that contains information about the digital image. This metadata is automatically written by the photographic device that captures the image. The metadata may include user supplied information that is stored prior to image capture and may also include metadata automatically supplied by the image capture device, including geographic location, date and time of image capture, width, length, resolution, pim information, compression information, f-number, etc. This information may be made available to anyone who desires additional information about the image or the image's author, i.e. creator.

Currently, an Internet user cannot easily access metadata for digital images once the digital image has been uploaded to a website. Further, the image author cannot associate the image with the contact information that may be used to communicate with the author. As such, an Internet user who wishes to communicate with the author of the image, cannot easily do so, given that currently, known methods do not allow the contact information to stay associated with the digital image. Also, images are currently not associated with metadata that includes communication options that can be used to communicate with a party associated with the image, such as email, instant messaging, etc.

### SUMMARY OF THE INVENTION

A method and system for associating metadata and other information materials with a digital image. In accordance with one aspect, an indication of selection of a hotspot on an image is received. A file associated with the hotspot on the image is determined. The file is transmitted for execution.

In accordance with another aspect, the present invention provides a computer readable storage medium, containing computer readable instructions, that when executed by the computer, cause the computer to perform a method including receiving an indication of selection of a hotspot on an image. A file associated with the hotspot on the image is determined. The file is transmitted for execution.

In accordance with another aspect, the present invention provides a computer including a storage device, a processor and a transmitter. The storage device is configured to store a file associated with a hotspot on an image. The processor is configured to receive an indication of selection of the hotspot on the image, and retrieve a file associated with the hotspot on the image from the storage device. The transmitter is configured to transmit the file for execution.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 shows an exemplary computer for processing metadata in accordance with the principles of the present invention;

FIG. 3 is an exemplary flow chart of a process of associating metadata with an image and uploading the metadata and the image to a server, in accordance with the principles of the present invention;

FIG. 4 is an exemplary flow chart of a process of viewing and displaying metadata in connection with an image;

FIG. 5 is an exemplary flow chart of an exemplary process of displaying metadata and communicating with a party associated with an image, in accordance with the principles of the present invention;

FIG. 6 is a block diagram of an exemplary system constructed in accordance with the principles of the present invention;

FIG. 7 is a block diagram of an exemplary display showing an image associated with a hotspot, in accordance with the principles of the present invention; and

FIG. 8 is a flowchart of an exemplary process for selecting a hotspot on an image, in accordance to the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for managing digital images. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

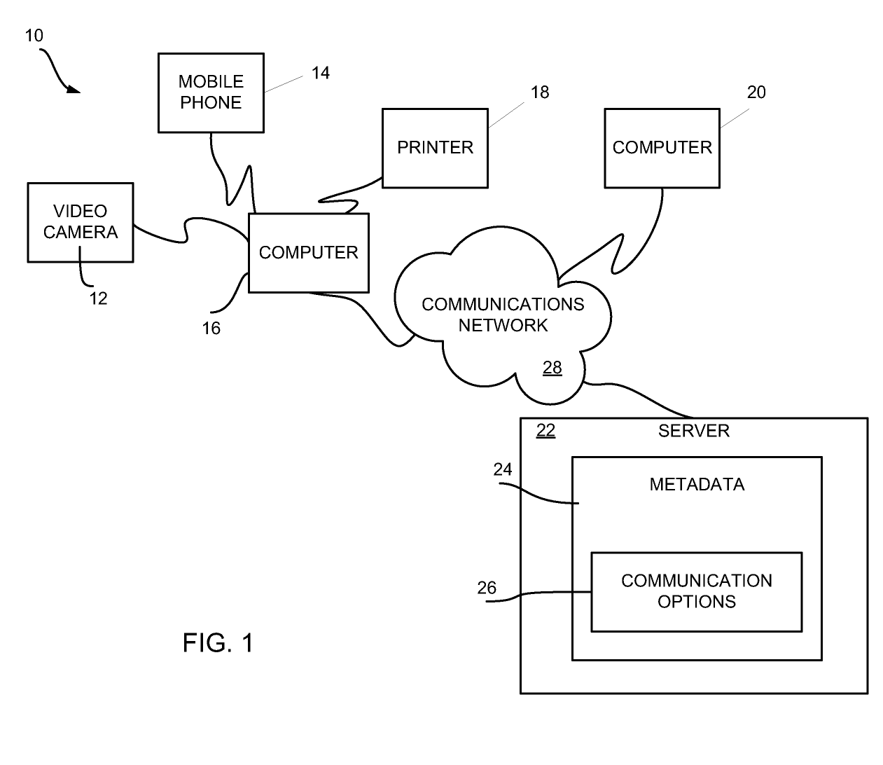

Referring now to the drawing figures in which reference designators refer to like elements, there is shown in FIG. 1 a block diagram of an exemplary system constructed in accordance with the principles of the present invention and designated generally as “10”. System 10 stores, transfers, and processes digital images, as well as metadata and additional information materials associated with the digital images. System 10 includes a camera 12 and/or a mobile phone 14 (referred to collectively as a Mobile Image Capture Device (MICD)) as well as a computer 16, a printer 18, a computer 20 and a server 22. Although FIG. 1 shows a single one of each of these devices, it is understood that more than one of these devices may be present. A digital image may be captured by the Mobile Image Capture Device (MICD). MICDs may include, for example, the IPHONE by APPLE, ANDROID phones by GOOGLE, and other devices from other manufacturers.

The MICD can be linked to a computer 16, wirelessly or by wired/optical connection, to transfer a captured digital image and metadata 24 associated with the image from the MICD 12 or 14 to the computer 16. Image and metadata 24 transfer may be automatic or in response to input by a user of the MICD. Thus, the MICD may include a transmission module that implements cellular, WiFi, satellite, infrared, cable, Local Area Network (LAN), or other communications technology to transfer the image and its metadata 24 to the computer 16. The computer 16 may be a laptop or desktop computer or portable computing device, such as a personal digital assistant. The image and metadata 24 can be printed by a printer 18 in communication with the computer 16.

As used herein, the term, “image,” includes a single captured image or a series of images, such as captured by a motion picture camera. The image may be stored as a jpg, bmp, tiff, avi, mpeg, rv, wmv, or other file type. The metadata 24 associated with the image may also be stored as one of a known file type, and may include audio files (such as way, mp3, aiff, pcm, wma, etc.). The metadata 24 of the image may be one of several standardized schemas for metadata, including EXIF, IPTC, XMP, Dublin Core and Plus. At least one of the metadata fields contains multiple communication options for communicating with a party associated with the image. At least one of the multiple communication options 26 may be selected by a user to communicate with a party associated with the image. Some of the communication options 26 available to communicate with a party associated with the image may include, but may not be limited to email, Short Message Service (SMS), blog, social media, video conference, Internet chat, Internet Protocol telephony, Internet forum, social network, virtual world gaming network and instant message. The multiple communication options 26 may be stored by a user before or after image capture.

In some embodiments, metadata 24 can be associated with the captured image by the camera 12 or mobile phone 14. Additionally, metadata 24 can be associated with the captured image by the computer 16. For example, a first set of metadata 24 can be associated with the image by the MICD 12 or 14. This first set of metadata 24 may be stored by a memory of the MICD. A second set of metadata 24 can be associated with the image by the computer 16. This second set of metadata 24 may be stored by a memory of the computer 16.

For example, the first set of metadata 24 may include the creator's name, the time and date of capture of the image, an identification of the MICD that captured the image, characteristics of the image, including size, chroma, lighting, etc., the GPS coordinates of the MICD at the time of capture, the dimensions of the captured image, the f-number, resolution, compression information, an audio file, etc. The first set of metadata 24 may also include communication options 26. Some of this first set of metadata 24 may be inputted before image capture by the user of the MICD, and some of the first set of metadata 24, such as GPS coordinates, can be automatically determined by the MICD. Some or all of the metadata 24 may be displayed at a display of the MICD, to allow the user to edit and approve the metadata 24.

The second set of metadata 24 may include audio files, video files, uniform resource locators (URLs), a description of the captured image, information concerning image sizes, symbols such as barcodes, and also communication options 26 for communicating with a party associated with the image, such as the author. Barcode data may be based, for example, on EAN, UPC, Code 25, Microsoft Tag, Neomedia Mobile Tag, QR Tags or the Shop Savvy Barcode system. For example, a bar code may be printed and/or decoded to provide information about the image to a user.

Some of the first or second set of metadata 24 can be input at the MICD 12 or 14 and some or all of the first or second set of metadata 24 can be associated with the image at the computer 16. The computer 16 can be connected to a server 22 via the Internet or other computer network 28, including the Public Switched Telephone Network (PSTN). An image stored in the computer 16 can be copied, along with the metadata 24 associated with the image, to the server 22. This transfer of the image and its metadata 24 from the MICD or computer 16 to the server 22 may be performed at any time after image capture. In addition, the image and its metadata 24 may be uploaded to the server 22 directly by the MICD 12 or 14. The server 22 stores metadata 24 and additional information materials associated with the image. In an exemplary embodiment, information materials may include communication options 26.

Once uploaded, the image and its metadata 24 may be accessible from the server 22 by another computer 20. Thus, in some embodiments, a file containing the image and its associated metadata 24 can be uploaded to the server 22, where it can be accessed at a website accessible to a plurality of computers connected to the Internet. Note that the site containing the image and its metadata 24 may not have any commercial nexus with the original author of the image, since ownership of the image may have been transferred or may be in the public domain. For example, an image uploaded to a social network site, such as FACEBOOK, may be in the public domain.

In some embodiments, an applet may be downloaded from a website at the request of a user. The applet enables a user to access or view metadata 24 of an image. The website providing the applet may be different from the website where an image and its metadata 24 are stored. The applet can automatically integrate into a web browser of the user or may remain separate. Current web browsers capable of integrating a downloaded applet include MICROSOFT INTERNET EXPLORER, GOOGLE'S CHROME, and MOZILLA FIREFOX, to name a few. The applet may be launched by clicking an icon provided on a tool bar of the web browser or may be launched by other input from the user, such as when the user selects the image.

When a user encounters a digital image of interest on the Web, he or she may select the image by clicking on the image, uttering a voice command, or otherwise indicating a selection of the image using a keyboard or mouse. The applet is then launched, and a window may appear in response to launching the applet. The window may enable the user to view metadata 24 or, alternatively, some or all of the metadata may be hidden from the user. The applet enables the user to view metadata 24 by executing a metadata viewer to examine the metadata fields contained in the digital image file. Online metadata viewers include Jeffrey's Exif Viewer at http://regex.info./exif.cgi.

The applet may find and retrieve a URL within the metadata 24. This URL address may be an address or pointer to a location of a website or file that contains the metadata and other information materials associated with the image by a user. In another embodiment, the hyperlink could be a link to a server of a photo processing center. Examples of photo processing centers include WALMART, WALGREENS, COSTCO, FLICKR, and SONY IMAGESTATION among others. The metadata 24 can then be processed at this center and the metadata 24 may contain information concerning the type of processing requested by the owner of the images associated with the metadata 24.

Once the metadata viewer locates the URL address, the user may then be taken to the URL location either automatically or upon request. At the URL location, a thumbnail and/or a large size copy of the image may be presented to the user. Also, the user may be presented with a list of materials associated with the digital image. These materials may include audio files, video files, text files, URL links and hyper links to other related information, encoded symbology, GPS location information, variations of the image including higher definitions of the image or different sizes of the image. The user may then select any of the listed information to view or download.

In an exemplary embodiment, metadata 24 includes communication options 26. Communication options 26 may include any communication option that can be used to communicate with any party, including a party associated with the image. Some of the communication options 26 available to communicate with a party associated with the image may include, but may not be limited to email, Short Message Service (SMS), blog, social media, video conference, Internet chat, Internet Protocol telephony, Internet forum, social network, virtual world gaming network and instant message. In another exemplary embodiment, a computer program, such as an applet, may retrieve information materials associated with the image, and the information materials may include communication options 26.

An Internet user may wish to communicate with a party associated with the image, such as the author. The user may select the image and, in response, a computer program, such as an applet, may cause the display of multiple communication options 26 associated with the image. As used herein, the term “select” includes “hovering” a pointing device, such as mouse, stylus or finger, over the image so that the cursor is over the image. In response to detecting this occurrence, multiple communication options 26 may be displayed. The user may hover over the image with a user input device, such as a mouse or stylus. Hovering includes, but is not limited to, holding a cursor over an image, “mousing” over the image, positioning a user input device over the image or using a user input device to temporarily select the image. For example, the user may hover over an image by positioning a cursor over an image without clicking the mouse. Hovering may be detected over an image and, in response to the hovering over the image, the multiple communication options 26 may be displayed. The Internet user may wish to communicate with the party via one of the communication options 26, and may select one of the communication options 26 to communicate with the party. A communication option selection may be received and a communication channel associated with the selected communication option may open to connect the Internet user with the party.

In an exemplary embodiment, a browser navigates to a website associated with one of the communication options 26. For example, if the Internet user wishes to communicate via a social network, a browser may navigate to the social network website. The Internet user may then send a “friend request” to the party associated with the image. In another exemplary embodiment, a computer program associated with the communication option selected may be run in response to selection of at least one of the multiple communication options 26. For example, the Internet user may select to communicate with the party via email. An email computer program may be started to allow communication between the Internet user and the party. Similarly, if the Internet user wishes to communicate with the party using Internet telephony, a computer program that implements Voice Over Internet Protocol (“VoIP”) may be started. The computer program may then dial the telephone number of the party associated with the image and connect the user to the party.

One of the communication options 26 may be a secure communication option, and as such, a password may be required to initiate communication using the secure communication option. For example, a party associated with the image may allow only predetermined people to contact them via video chat. As such, an Internet user who wishes to communicate with the party via video chat may be required to enter a password or another type of security verification.

Additionally, one of the communication options 26 may be automatically activated in response to selection of the image. The communication option may be predetermined by a party associated with the image. An Internet user may also preselect which one of the communication options 26 may be activated in response to selection of the image. For example, the Internet user may preregister at a website containing the image, and may create a user profile that stores a user preferred communication option, so that the preferred communication option may be activated automatically when the user selects the image.

Similarly, other actions may be activated in response to selection of the image. In an exemplary embodiment, if there is only one type of material associated with the image, for example, a single audio file, then that file may be displayed, played, or activated automatically. Also, even if there are multiple materials associated with the image, anyone of them may be chosen to be activated automatically when the user selects the image. For example, an Internet user may select an image and in response to the selection, a video file, an audio file, and a multimedia file may automatically be played.

Thus, a user may capture an image using an MICD. The MICD or a user may associate metadata with the image. The image and its metadata may be stored in a local memory of the MICD. A communications module of the MICD may transfer the image and its metadata to a local or remote computer or to external memory. The local or remote computer and the external memory may be connected to the Internet.

Once stored, a user (who may be different from the image author) may access the image at the storage location, and click on, or otherwise select the image using a user interface that may be a touch screen user interface, a voice activated user interface, etc. When the user selects the image, an applet may automatically be activated or may be activated upon selection by the user. As is discussed below, the metadata 24 can be embedded as part of the image or stored separately. The activated applet may activate a metadata viewer to examine the metadata fields, including a URL field, contained in the digital image file that links to a website or file that has the image, the metadata, and information a user has associated with the image. The metadata fields may include a plurality of communication options 26. The metadata viewer may enable offline or online viewing of the metadata 24.

Once the metadata viewer ascertains the URL of the location of the materials associated with the image, the user may be taken to the URL location automatically or upon request by the user. At that location, a thumbnail of the digital image may be shown to the user or alternatively a full size copy of the image may be displayed. The metadata viewer may also display the plurality of communication options 26 and may activate one of the plurality of communication options 26 to communicate with the party associated with the image. The activated communication option may be selected by the user or may be chosen in advance by the author of the image or another party to be activated automatically.

Computer options 26 may include contact information for a party associated with the image, which may include but may not be limited to, the party's email address, telephone number, social media identification, physical address, fax number, web address, etc. A list of information materials associated with the image may also be displayed. These information materials may include audio files, video files, text files, URLs and hyperlinks to other related information, encoded symbology, GPS location information, higher definitions of the image, and different sizes of the image. Note that one or more of these related information may be played, activated, or displayed automatically or upon selection by the user. The information materials to be activated automatically may be chosen in advance by an author of the image or another person. For example, if a user selects an image from a local memory and then requests information about the image, an audio file may automatically activate and play, thereby giving the audio information about the image. The audio information may include a verbal statement about the image and may include music chosen by the author of the image. As another example, a video file having information about the image may be activated automatically or upon selection. The information materials may also include multimedia files, e.g., files that combine audio and video.

Note also that the user may print out the image and its metadata 24, including, if selected, encoded symbology associated with the image. This symbology may be used by the MICD or a scanning device and may direct the user to the location of the image and its metadata 24. The user may also choose to email the image and its metadata 24 as a file attachment to an email, by choosing email as a communication option. The user may also include a link in the email that points to a storage location of the image.

Thus, one embodiment is a method of associating metadata with a digital image. The method includes associating an image with metadata that includes multiple communication options 26, and providing an applet to view the metadata in response to selection of the image. The method includes communicating with a party associated with the image using at least one of the plurality of communication options 26. The multiple communication options 26 may include, but not be limited to at least one of email, Short Message Service (SMS), blog, social media, video conference, Internet chat, Internet Protocol telephony, Internet forum, social network, virtual world gaming network and instant message.

The metadata may also include a URL that links to a website. A browser may navigate to the website pointed to by the URL. The website may display a list of selectable information materials associated with the image. The information materials associated with the image may include an audio file, a video file, a text file, and/or an encoded symbol. At least one of the audio file, and the video file, may automatically be activated when the browser reaches the website indicated by the URL.

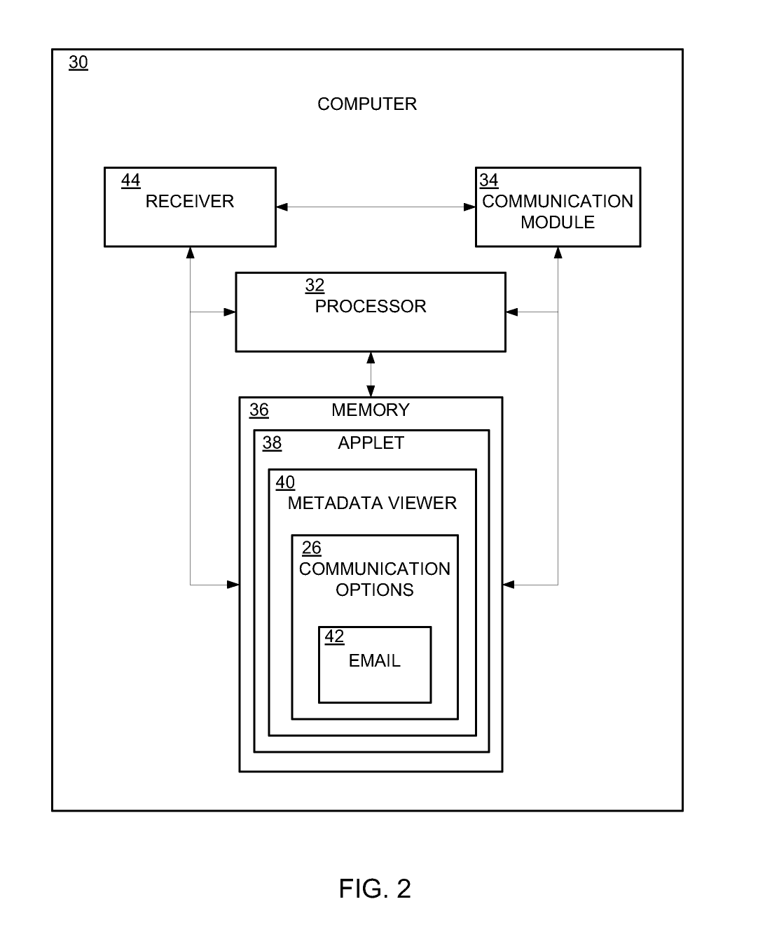

FIG. 2 shows a computer 30 having a processor 32, a communication module 34, a memory 36 and receiver 44 for processing metadata as described herein. The computer 30 may be a desktop computer, a laptop computer, a personal digital assistant, a mobile device, a tablet PC, etc. The computer 30 has a processor 32 for executing computer instructions stored in the memory 36. The memory 36 may be a hard drive, Random Access Memory (RAM), Read Only Memory (ROM), flash memory, compact disc, external memory, etc. Computer instructions stored in the memory 36 may include an applet 38 which includes a metadata viewer 40, which is used to view communication options 26. Communication options 26, may include, for example, an option to communicate via email 42.

Thus, one embodiment is an apparatus for associating metadata 24 with an image. The apparatus comprises a memory 36, a communication module 34, a receiver 44 and a processor 32. A user may select an image associated with metadata that includes multiple communication options 26. Receiver 44 may receive the image selection. The memory 36 may store metadata 24 in a memory location that is associated with the image. The processor 30 is operable to examine the metadata 24 and perform an operation based on the metadata 24. For example, the operation performed by the processor 30 may cause the metadata 24, including communication options 26, to be displayed. The operation may further include causing the communication module 34 to communicate with a party associated with the image using at least one of the plurality of communication options 26. An Internet user may select one of the communication options 26 to communicate with the party associated with the image. The selected communication option may be received by receiver 44. Communication module 34 may communicate with the party using the selected communication option.

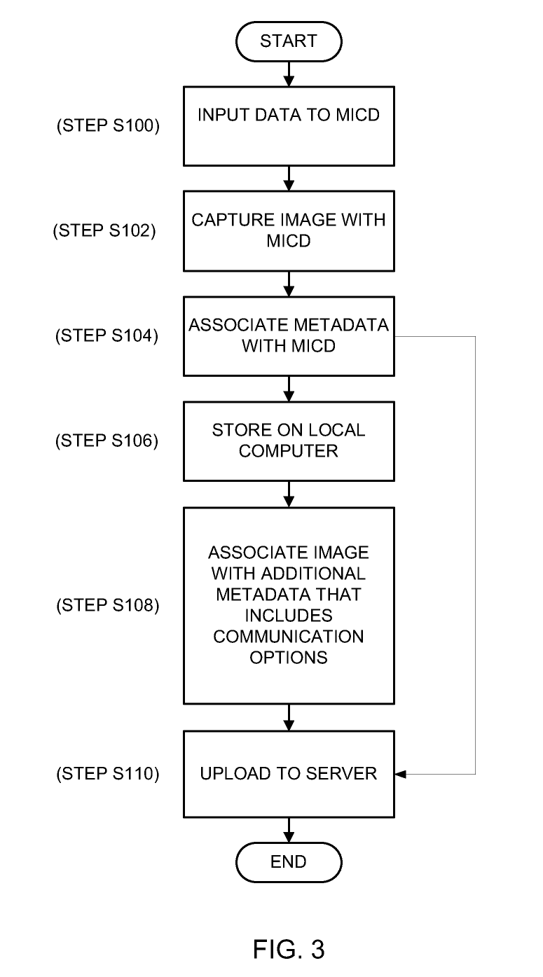

FIG. 3 is a flow chart of an exemplary process for associating metadata with an image. A user of an MICD inputs metadata to the MICD (Step S100). The metadata 24 inputted by the user may include the user's name, address or email address, and phone number. The metadata 24 may also include different communication options 26 that may be used to communicate with a party associated with an image. The user captures an image with the MICD (Step S102). The MICD associates the image with metadata 24 (Step S104). The metadata 24 associated with the image by the MICD includes the metadata 24 inputted by the user at Step S100, and may also include metadata 24 automatically ascertained by the MICD. The metadata 24 automatically ascertained by the MICD may include a make and model of the MICD, GPS location at the time of image capture, time and date of image capture, camera settings such as focal length, etc. This metadata 24 may be associated with the image by storing the metadata 24 in a file that contains the image data. Or the image data file may contain a pointer to a metadata file or vice versa.

The image and metadata 24 may be transferred from the MICD to a memory storage device on a local computer (Step S106). Alternatively, the image and metadata may be uploaded to a server via the Internet directly from the MICD (Step S110). A user, who may be different from the person who captured the image, may add metadata, including communication options 26, to the metadata 24 already associated with the image, and may associate additional information and materials with the image (Step S108). The added metadata and information materials may contain files or links to files, such as audio files, video files, and text files. For example, an audio file may contain a verbal description of the image. A text file may contain the names of persons in the image. The image and its metadata and information materials may be uploaded to a server via the Internet (Step S110). In one embodiment, the metadata may be stored in a first location and the image may be stored in a second location. In another embodiment, at least a portion of the metadata is embedded in the digital image itself and includes a hyperlink to additional materials.

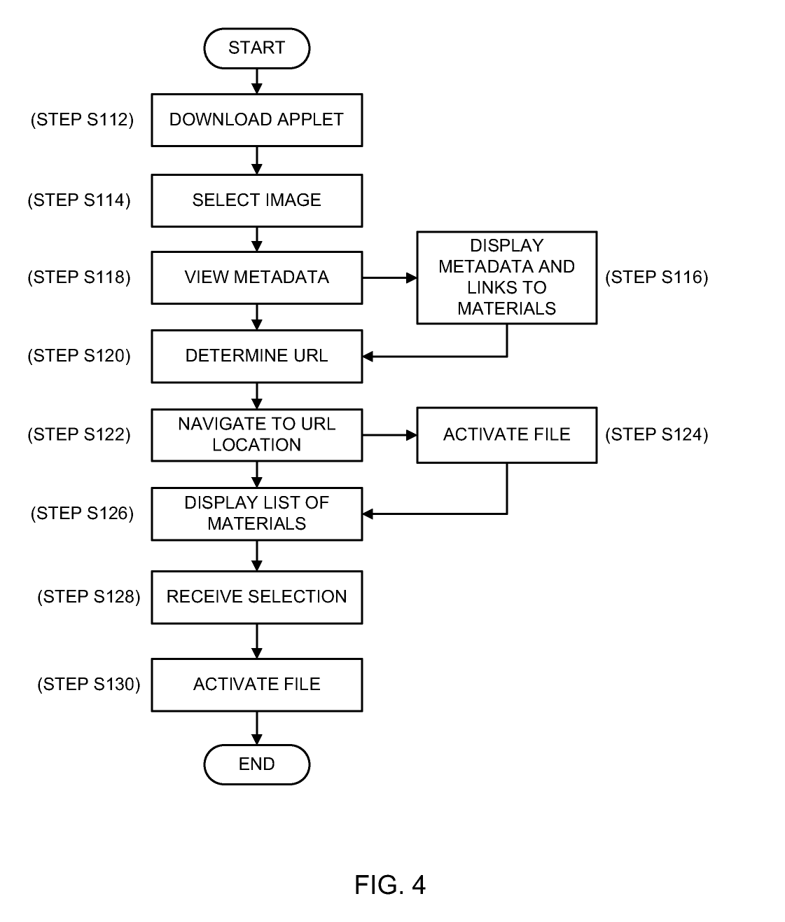

FIG. 4 is a flow chart of an exemplary process for selecting an image and viewing its metadata 24. A user may download an applet 38 that has a metadata viewer 40 (Step S112). The user selects an image that is displayed at a webpage (Step S114). In response to selection of the image, the applet may display the metadata of the selected image (Step S118). Some or all of the metadata may be displayed, with links to related information materials obtained from the metadata (Step S116). In some embodiments, the image is located on a computer of the user and when the image is selected, a hyperlink is activated that takes a user's web browser to a remote address designated by the hyperlink where the information materials are located

A computer program, such as applet 38, may determine a URL in a field of the metadata of the selected image (Step S120). This URL may point to a website that has a list of links to information materials related to the image such as audio files, video files, and text files. Upon determining the URL, or in response to user input, the user's web browser may navigate to the website pointed to by the URL (Step S122). At the website, the web browser may automatically activate a file, such as an audio file, associated with the image (Step S124). The browser displays a list of information materials associated with the image (Step S126). The user may then select a material, by clicking on a link to the material, or by voice command, or other known means (Step S128). Upon selection, the browser may then activate the selected file (Step S130).

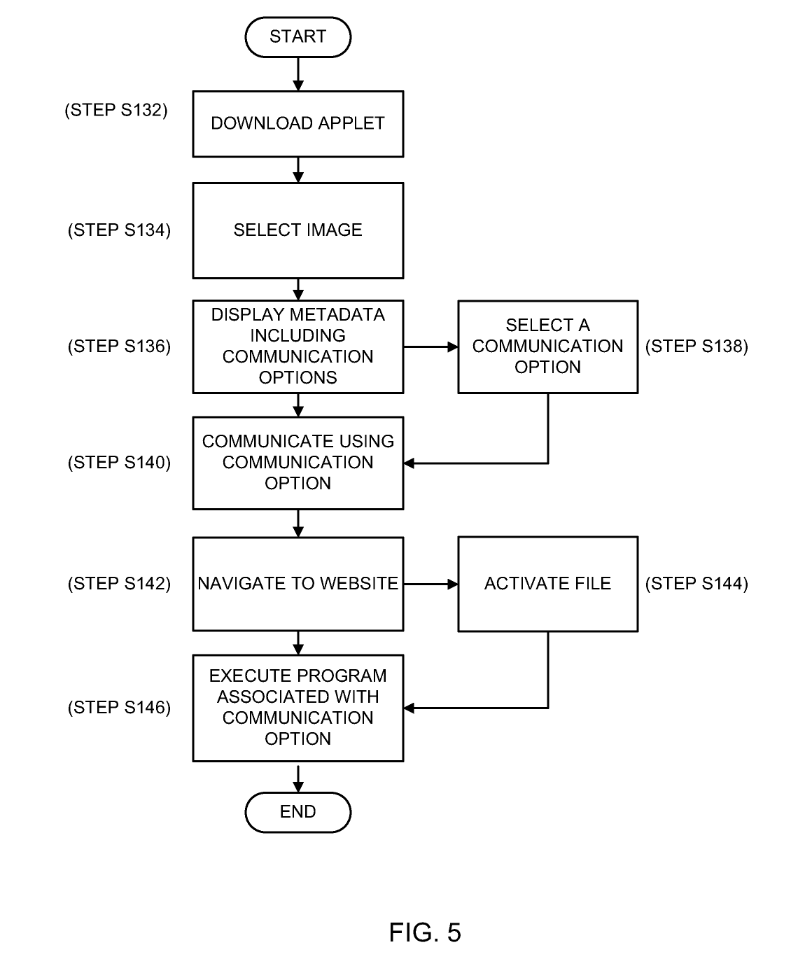

FIG. 5 is a flow chart of an exemplary process for selecting an image and viewing its metadata 24. A computer program with a metadata viewer 40, such as applet 38, may be downloaded (Step S132). An image displayed on a webpage may be selected (Step S134). In response to selection of the image, the metadata or a representation of the metadata, e.g., website link, of the selected image may be displayed. The metadata may include communication options 26 (Step S136). In one embodiment, a user may select a communication option to communicate with a party associated with the image (Step S138). In another embodiment, a communication option may be automatically selected for the user in response to image selection. Communication options 26 may include any available communication method available, including, but not limited to email, Short Message Service (SMS), blog, social media, video conference, Internet chat, Internet Protocol telephony, Internet forum, social network, virtual world gaming network and instant message. Some of the communication options 26 may be secure communication options and may require a user to enter a password to initiate communication with the party.

One of the communication options 26, such as the user selected communication option, may be used to communicate with a party associated with the image (Step S140). A web browser may navigate to a website associated with the selected communication option (Step S142). For example, if the user chooses to communicate via a social media website, such as FACEBOOK, the web browser may navigate to the FACEBOOK webpage. A file, such as a video file, an audio file, a multimedia file, etc. may be automatically activated (Step S144). Additionally, a program associated with one of the communication options 26 may be executed (Step S146), such as an email program. The program may be used to send data and files to the party associated with the image, such as a video file, an image file, a text file, a multimedia file, etc.

One embodiment of the invention is a computer readable medium containing computer readable instructions, that when executed by the computer, cause the computer to perform functions for processing metadata 24 related to an image. For example, the instructions may cause the computer to display metadata 24 associated with the image, evaluate the metadata, and perform an operation based on the metadata. The metadata may include communication options 26. In an exemplary embodiment, the operations may include receiving an image selection. The operations may include displaying metadata 24 and information materials derived from the metadata 24 in response to selection of the image. The operations may further include communicating with a party associated with the image using one of the communication options 26. The operations may also include playing a multimedia, video file and/or audio file when the image is selected.

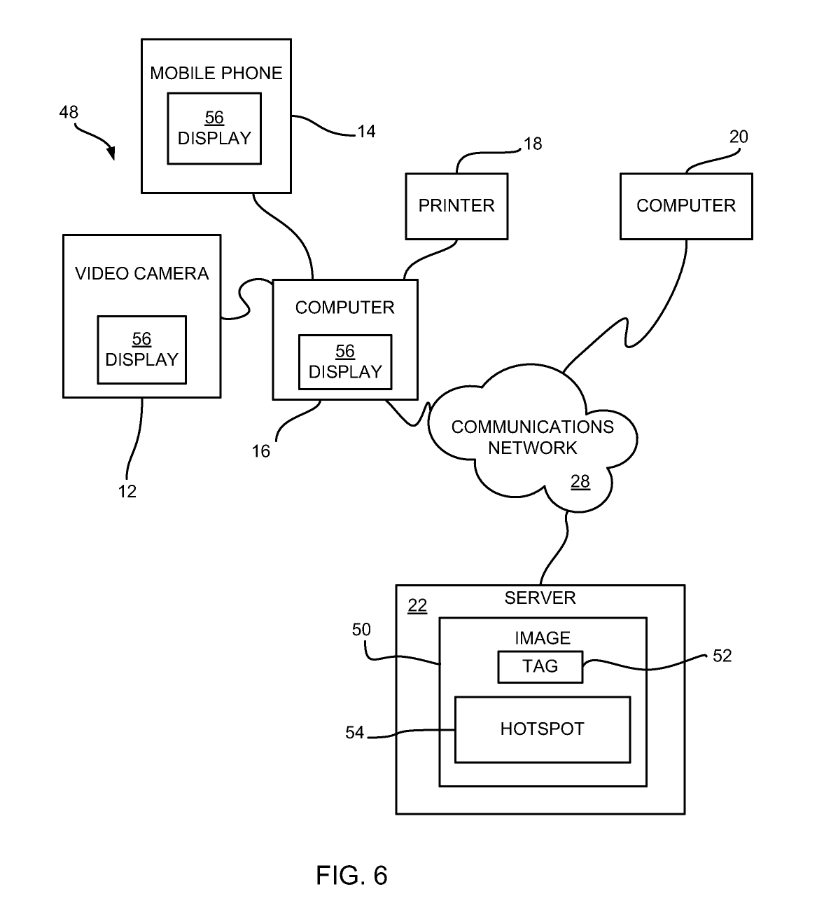

In accordance with another embodiment, a system and method are provided in which a hotspot in an image is associated with a file, such as a multimedia file that is executable by the user's computing device. An exemplary embodiment is described with reference to the block diagram of FIG. 6. FIG. 6 is a block diagram of an exemplary system designated generally as “48.” System 48 stores, transfers, and processes digital image 50, as well as metadata and additional information materials associated with the digital image 50. Digital image 50 may be associated with tag 52 and hotspot 54. System 48 includes camera 12, mobile phone 14, computer 16, printer 18, computer 20 and server 22. Although FIG. 6 shows a single one of each of these user devices, it is understood that more than one of these user devices may be present. Computer 16 may be a tablet computer, a laptop computer, a personal digital assistant, or any computing device capable of displaying image 50.

In an exemplary embodiment, digital image 50 may be captured by a user device, such as camera 12 and mobile phone 14, and transmitted for storage to computers 16, 20 and/or server 22. In another exemplary embodiment, server 22 may store digital image 50 and may transmit digital image 50 for display at a user device, such as camera 12, mobile phone 14 and computer 16. Camera 12, mobile phone 14 and computer 16 can be linked to server 22, wirelessly or by wired/optical connection, in order to transfer or receive image 50, tag 52 and hotspot 54. Image 50, tag 52 and hotspot 54 are transferred to server 22 automatically or in response to input by a user of camera 12, mobile phone 14 and computer 16.

Tag 52 that may include keywords related to image 50. For example, image 50 may be an image of a beach. As such, tag 52 may include the words “beach,” “ocean,” “vacation,” “sand,” etc. Tag 52 may be implemented as a voice tag that includes a recording of keywords related to image 50. Image 50 further includes hotspot 54. Hotspot 54 contains one or more clickable or selectable sections which may be associated with a file, a hyperlink or a command. A hyperlink associated with hotspot 54 may be an absolute or a relative link. An absolute link associated with hotspot 54 may link to a webpage using a complete Uniform Resource Locator (“URL”). A relative link associated with hotspot 54 may include a path to a file, a file name, a file handle or any file identification matching a particular file.

Hotspot 54 on image 50 is associated with a portion of image 50 and has a shape, including but not limited to a circular, polygonal or rectangular shape. Any subset of pixels in image 50 may be defined as hotspot 54. Hotspot 54 may also be defined by an area on image 50, such as the area including the face of a person in image 50. The dimension of hotspot 54 may depend on the dimension of the area, which, in this example, may be the dimension of the face area. Further, hotspot 54 may contain non-contiguous regions which may be used to represent a group of objects or persons. For example, a group of people in image 50 may be associated with hotspot 54, which may display the words “Class of 2012” when a user hovers over hotspot 54.

Hotspot 54 may be associated with information on an object, location, person, or anything included in image 50. The information may also include other data that may be associated with image 50. For example, if image 50 is a picture of a person playing football, hotspot 54 may be associated with an audio file identifying not only the name of the person playing, but also the name of other people in the football team, even though the other people are not shown in image 50. Selection of hotspot 54 causes server 22 to perform an action, execute a file, run a command or open a webpage. In an exemplary embodiment, selecting hotspot 54 retrieves a particular web page from a web server. In another exemplary embodiment, selecting or hovering over hotspot 54 on image 50 triggers the execution of a file associated with image 50. Server 22 sends to a user device, such as camera 12, mobile phone 14 and computer 16, a file upon detecting hovering over hotspot 54. Multiple hotspots 54 within a single image 50 may be linkable to different websites, may trigger different actions, and/or may be associated with different types of files.

In an exemplary embodiment, a search for image 50 may be performed using a program having visual search technology capabilities, such as a web browser. A user or computer program searches for image 50 in order to associate image 50 with tag 52 and/or hotspot 54. A visual search engine is used to find visual information contained in image 50. Image 50 may include a video, a presentation, multimedia graphics, etc. stored in server 22 or computer network 28. In order to search for image 50, the visual search engine may rely on characteristics of image 50, including, but not limited to color, shape, shadows, resolution, size, etc., to recognize and identify image 50. By way of example, a visual search for images 50 that include a particular object in a particular color, such as a picture of a red car, will return identical and/or similar images of red cars.

In an exemplary embodiment, a user may wish to search for image 50 containing a person, particularly, containing the face of the person. Facial recognition may be used by the visual search engine to identify the person in image 50. The visual search engine determines facial characteristics using facial recognition algorithms. Facial characteristics may include, but not be limited to the distance between the eyes, the length and width of the face, the color of the skin/eyes/hair, and the shape of the face, among others. The visual search engine searches for images that include the determined characteristics. Once server 22 finds image 50, image 50 is transmitted to a user device, such as computer 16 or mobile phone 14, so that image 50 may be modified to include and/or be associated with at least one of hotspot 54 and tag 52.

On the other hand, a search of image 50 may be performed where image 50 may already be associated with hotspot 54 and/or tag 52. A person may wish to search all images 50 that include hotspot 54 associated with a particular file, command or URL. By way of example, a person may search for images 50 with hotspot 54 associated with a particular file that includes a recording of the person's name. For example, a search for image 50 including hotspot 54 associated with a recording that identifies a person in image 50 as “John Smith,” may be undertaken. Server 22 searches multiple images in order to find and transmit image 50 to a user device, such as computer 16 or mobile phone 14.

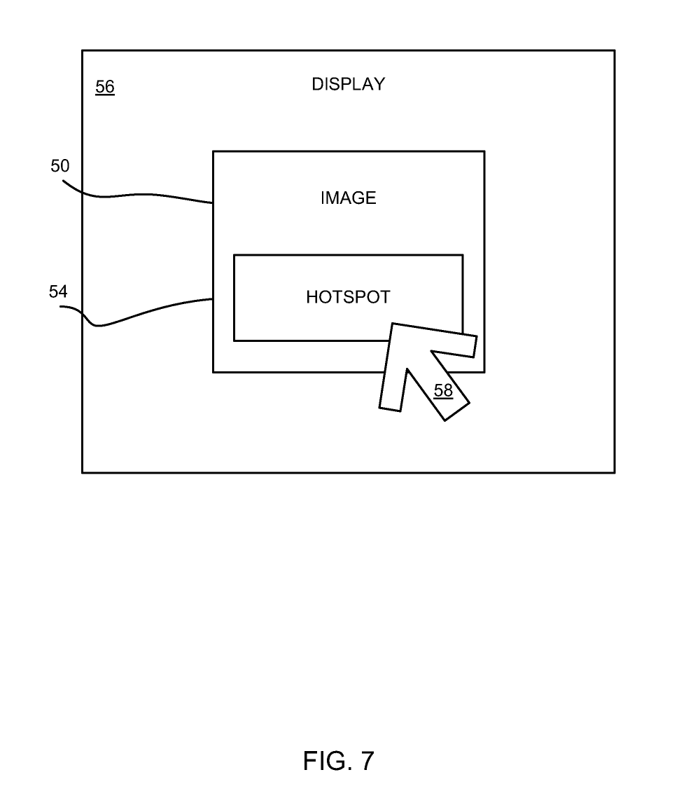

FIG. 7 is a block diagram of an exemplary display 56 of a user device displaying image 50, in accordance with the principles of the present invention. A user device may be any device capable of displaying image 50, such as camera 12, mobile phone 14, computer 16, a tablet computer, a laptop computer, or any other type of computing device having display 56. Display 56 may be a touch screen display that may respond to tactile input, a light-emitting diode display, a plasma display, a liquid crystal display, a thin film transistor display, among others.

In an exemplary embodiment, a user's movement of mouse 58 over hotspot 54, i.e., hovering, causes data indicating selection of hotspot 54 to be sent to server 22. Mouse 58 may be any input device used to select hotspot 54, such as a stylus or a user's finger. Server 22 receives data indicating that hotspot 54 has been selected and/or activated by mouse 58 hovering upon hotspot 54. Server 22 determines whether hotspot 54 is associated with information, such as a particular file, a command, a message or a URL. Information may be stored in server 22 or may be downloadable via computer network 28. The information may be stored in different formats, including but not limited to a data structure in the form of arrays in memory, a file, or in a database.

Once server 22 receives an indication that a user has selected or is hovering over hotspot 54 on image 50, server 22 transmits a file associated with hotspot 54 to the user, device, i.e., computer 16, mobile phone 14, video camera 12, a tablet computer, a laptop computer, etc., so that the file may be executed at the user device. A user passing cursor 58 via a mouse or other pointing device over hotspot 54, may cause data to be displayed, for example, in the form of a dynamically created floating panel. When hotspot 54 is selected or hovering over hotspot 54 is detected, server 22 may transmit a file or command to the user device for execution.

In an exemplary embodiment, image 50 includes hotspot 54 associated with a media file that may include text, graphics, video and/or audio. The file may be stored as one of a particular file type. The file may be an executable user application and may include any file format used for user software, such as a wave audio file (“way”), Movie Pictures Experts Group (“MPEG”) audio layer 3 (“mp3”), audio interchange file format (“aiff”), pulse code modulation (“pcm”), Windows® media audio (“wma”), audio video interleave (“avi”), Quicktime® movie file (“mov”), advance systems format (“asf”), Windows® media video (“wmv”), MPEG audio layer 4 (“mp4”), Movie Picture Group (“mpg”), flash video (“fly”), DivXNetworks (“dvix”), mpeg-1, mpeg-2 program stream (“mpeg-2 ps”), mpeg-2 transport stream (“mpeg-2 ts”), Apple® m4v, Joint Photographic Experts Group (“jpeg”), motion jpeg (“m-jpeg”), bitmap (“bmp”), jpeg 2 (“JP2”), Pixar image computer image file (“pxr”), tagged image file format (“tiff”), graphics interchange format (“gif”), etc., Power Point Show® (“pps”), among other file formats.

The file associated with hotspot 53 may appear and execute, i.e., play on the user's display 56 upon a user initiating execution of the file. The file may be a software executable file including execution instructions for a program. Upon execution, the file will cause, after obtaining the corresponding permissions from the operating system, certain actions to occur. For example, a document processing program, such as Microsoft Word® or a game, like Doom® may execute. Additionally, the file may execute an email program, browser program, movie player program, business program, etc.

When hotspot 54 is selected, server 22 transmits the media file to a user device for execution. The media file may include identifying information corresponding to a person in the image. By way of example, the media file may include an audio recording message stating at least one of the name, age, profession, address, telephone number, email address, social media identification, FACEBOOK® user identification and/or any other information associated with the person in image 50.

Further, the media file may include, but may not be limited to a recording identifying an online profile user identification, a web address, the age, sex, education, work history and resume of a person in the image, a list of addresses of a person's contacts, family history and genealogy, group memberships, user names, friend's names, events associated with a person, a person's favorite retailers, shopping habits, a list of property owned by a person, previous names used, affiliations links to contacts, social and professional networks, information related to life events, such as a marriage or divorce, military service, a person's preferences or tastes, goods bought, taxes information, credit rating, corporations associated with a person, assets and liabilities, income and bank accounts associated with a person in the image. The media file may further include, but may not be limited to, a description of the scene on image 50, an action associated with image 50, or a description of the people in image 50.

To navigate to hotspot 54 within image 50, any technique may be used. For example, a user may select or manually enter the coordinates of the bounding area of hotspot 54 in order to activate hotspot 54. A user selects hotspot 54 on image 50 or hovers over hotspot 54 and, in response, server 22 determines which file, command, URL or action is associated with hotspot 54. By way of example, a file associated with hotspot 54 may be stored in server 22 or may be downloaded by server 22 or a user device from computer network 28 upon selection of hotspot 54. The associated file is transmitted back to the user device for execution. The user device may include computer 16, video camera 12, and mobile phone 14, among other devices. The file may be transmitted via Hypertext Transfer Protocol (“HTTP”), File Transfer Protocol (“FTP”), User Datagram Protocol (“UDP”), UDP-based data Transfer Protocol, File Service Protocol, Single File Transfer Protocol, etc., among other communication protocols. The file may also be sent to an email address, a social media user identification, a mobile device number, or sent as a Short Message Service (“SMS”).

In another exemplary embodiment, hotspot 54 may be associated with a default message. For example, when a user hovers upon hotspot 54, a default message may be displayed in a pop-up window or a default hyperlink may be opened by a browser. The default message may state that image 50 is currently not associated with a file, and may invite the user to associate image 50 with a file. The message displays a list of files the user may browse through and associate with hotspot 54. The user may associate hotpot 54 with one or multiple files. The file may reside in the user's device, server 22 or may be downloaded from computer network 28. A user may also choose to record a voice file and associate the recording with image 50. The recording may include a date and time associated with image 50, a description of image 50, a song, the names of people in image 50, the names of people associated with the people in image 50, an identification of an animal/object/place in image 50, and any other information that the user wishes to associate with image 50.

In an exemplary embodiment, a database stores a command, file, or action to be executed upon detecting hovering over hotspot 54. The database also stores information associated with hotspot 54, such as a name of a place/object/person in image 50, an identification of image 50, a description of image 50, a time, date, and location associated with image 50, an action to be taken in response to detecting hovering over image 50, a name of a file associated with hotspot 54, a recording associated with hotspot 54, etc. Further, the database may store the different actions that may be taken depending on whether a user hovers over hotspot 54 or whether a user clicks on hotspot 54. For example, hovering over hotspot 54 may cause a message to pop-up, while clicking on hotspot 54 may cause a web browser to navigate to a website or an audio file to be opened/executed.

A hotspot 54 may be implemented, i.e., defined, either on a client side, such as on a user's device, or on a server 22 side. A hotspot 54 implemented on a client side, such as computer 16, may cause the client to determine whether mouse 58 is over hotspot 54, while a hotspot 54 implemented on a server 22 side may cause the user device to send the coordinates of mouse 58 to server 22. Server 22 may determine that mouse 58 is over hotspot 54, and may transmit information, such as a file to be executed, to the client/user device via computer network 28.

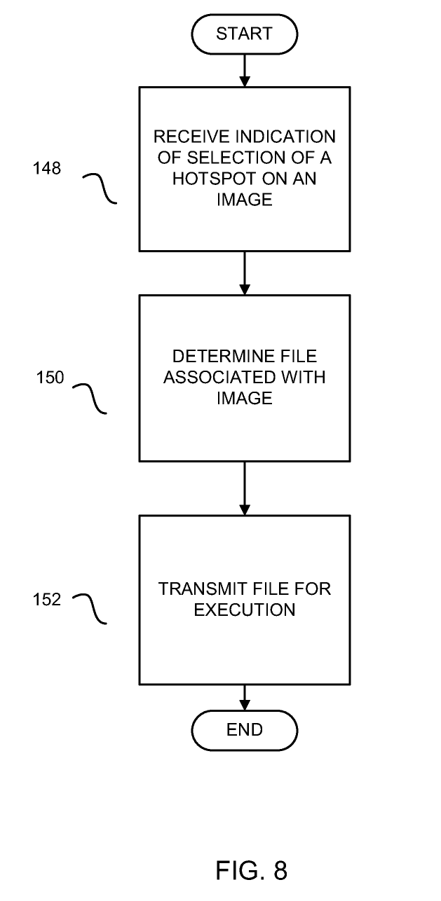

FIG. 8 is a flow chart of an exemplary process for receiving an indication that hotspot 54 on image 50 has been selected. An indication of selection of hotspot 54 on image 50 is received (Block 148). A determination is made as to which file is associated with hotspot 54 (Block 150). The file associated with hotspot 54 is transmitted to the user device for execution (Block 152). The file may be an audio file including a recording identifying a person on image 50. The audio file may be executed upon detecting hovering over hotspot 54. The file may include a recording of a person's name, their background, profession, age, marital status, address, telephone number, work place, education, work experience, family relationships, education, etc. The recording is played at the user device

In another exemplary embodiment, hotspot 54 may be associated with a message. Hovering over hotspot 54 may be detected and in response, a message may appear informing a user that hotspot 54 is not associated with a file. The message gives the user an opportunity to choose a file to associate with hotspot 54 on image 50. The message displays a list of files that may be chosen to associate with hotspot 54. The user may browse through the list of files to choose a file to associate with hotspot 54. The associated file may be saved on server 22. Once hotspot 54 is associated with a file, hovering over hotspot 54 will cause server 22 to transmit the associated file to a user device, such as computer 16 or mobile phone 14 for execution.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile, non-volatile, non transitory computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method, comprising:
receiving an indication of selection of a hotspot on an image;
determining a file associated with the hotspot on the image; and
transmitting the file for execution.

2. The method of claim 1, wherein the file is a media file and includes at least one of audio, video, text and graphics.

3. The method of claim 1, wherein the file is an executable user application.

4. The method of claim 1, further comprising:
searching for the image using visual search technology; and
storing the image and the file associated with the hotspot on the image.

5. The method of claim 1, wherein the image includes a picture of a person, and the file includes a recording identifying the person.

6. The method of claim 1, wherein the file includes a recording describing the image.

7. The method of claim 1, wherein the hotspot is one of a plurality of hotspots in the image.

8. The method of claim 1, wherein the hotspot is associated with a command, the method further comprising:
transmitting the command to a computer for execution at the computer.

9. A computer readable storage medium having stored therein computer readable instructions, that when executed by the computer, cause the computer to perform a method comprising:
receiving an indication of selection of a hotspot on an image;
determining a file associated with the hotspot on the image; and
transmitting the file for execution.

10. The computer readable storage medium of claim 9, wherein the file is a media file and includes at least one of audio, video, text and graphics.

11. The computer readable storage medium of claim 9, the method further comprising:
searching for the image using visual search technology; and
storing the image and the file associated with the hotspot on the image.

12. The computer readable storage medium of claim 9, wherein the image includes a picture of a person, and the file includes a recording identifying the person.

13. The computer readable storage medium of claim 9, wherein the file includes a recording describing the image.

14. The computer readable storage medium of claim 9, wherein the hotspot is one of a plurality of hotspots in the image.

15. The computer readable storage medium of claim 9, wherein the hotspot is associated with a command, wherein the command is transmitted to a computer for execution at the computer.

16. A computer, comprising:
a storage device, the storage device configured to store a file associated with a hotspot on an image;
a processor, the processor configured to:
receive an indication of selection of the hotspot on the image;
retrieve the file associated with the hotspot on the image from the storage device; and
a transmitter, the transmitter configured to:
transmit the file for execution.

17. The computer of claim 16, wherein the file is a media file and includes at least one of audio, video, text and graphics.

18. The computer of claim 16, the processor further configured to perform:
searching for the image using visual search technology; and
the storage device further configured to store the image and the file associated with the hotspot on the image.

19. The computer of claim 16, wherein the image includes a picture of a person, and the file includes a recording identifying the person.

20. The computer of claim 16, wherein the file includes a recording describing the image.

21. The computer of claim 19, wherein the recording identifying the person includes the name of the person.
